(19) United States
(12) Patent Application Publication
(10) Pub. No.: US 2006/0103897 A1
(43) Pub. Date: May 18, 2006

(54) Scanning device

(76) Inventor: Ming-Kuan Qian, TaiZhou City (CN)

Correspondence Address: RABIN & Berdo, PC, 1101 14TH STREET, NW, SUITE 500, WASHINGTON, DC, 20005, US

(21) Appl. No.: 11/273,030

(22) Filed: Nov. 15, 2005

(30) Foreign Application Priority Data
Nov. 18, 2004 (TW) 93135502

(51) Int. Cl. H04N 1/04

(52) U.S. Cl. 358/474

(57) ABSTRACT

A scanning device including a scanning platform, a bar, a carriage, a contact image sensor, a positioning member and an elastic member is provided. The bar disposed below the scanning platform is parallel to the first edge. The carriage has a bottom surface and a top surface. The bottom surface has a receiving part for receiving the bar. The top surface faces the scanning platform. The carriage is slideably moved below the scanning platform along the bar. The contact image sensor disposed on the top surface is for scanning a document. The positioning member which is slideably or rotatably disposed on the bottom surface is for pressing against the bar. The elastic member is connected to the carriage and the positioning member and provides an elastic force to the positioning member. The elastic force transmitted to the bar enables the contact image sensor to press the scanning platform tightly.

This application claims the benefit of Taiwan application Serial No. 93135502, filed Nov. 18, 2004, the subject matter of which is incorporated herein by reference.

### BACKGROUND OF THE INVENTION

1. Field of the Invention

The invention relates in general to a scanning device, and more particularly to a scanning device capable of maintaining a constant distance between a contact image sensor and a scanning platform.

2. Description of the Related Art

Scanning quality is crucial to the competitiveness of scanner. Scanners are divided into two types according whether a charged coupled device or a contact image sensor is used.

The advantage of the scanner using contact image sensor is that the contact image sensor can be modularized. For example, the light source, the sensor and the amplifier can be integrated. The structure and theory of the scanner using contact image sensor are very simple, the manufacturing cost can be largely reduced. Furthermore, the size of the product can be designed to be slimmer and lighter but have a wider range of application.

A commonly encounter problem for scanner using contact image sensor is that the contact image sensor is unable to keep a constant distance with the scanner and maintain the scanning depth stable, greatly affecting the scanning quality and reducing the acceptance level.

### SUMMARY OF THE INVENTION

It is therefore the object of the invention to provide a scanning device capable of keeping a constant distance between image sensor and the glass on the scanning platform to improve image scanning quality.

According to an object of the invention, a scanning device including a scanning platform, a bar, a carriage, a contact image sensor, a positioning member and an elastic member is provided. The scanning platform for placing a document has a first edge and a second edge. The first edge and the second edge define a plane normal direction. The bar is parallel to the first edge to be disposed below the scanning platform. The carriage has a bottom surface and a top surface. The top surface faces the scanning platform. The bottom surface has a receiving part for receiving the bar. The carriage is slideably moved below the scanning platform along an extending direction of the bar. The contact image sensor disposed on the top surface is used for scanning a document. The positioning member is slideably or rotatably disposed on the bottom surface and is used for pressing against the bar. The elastic member is connected to the carriage and the positioning member and provides an elastic force to the positioning member. The elastic force enables the positioning member and the receiving part to apply on the bar, so that the contact image sensor presses the scanning platform tightly.

According to another object of the invention, a scanning device is provided. The scanning device is disposed below a scanning platform. The scanning platform is used for placing a document and has a first edge and a second edge. The first edge and the second edge define a plane normal direction. The scanning device includes a bar, a carriage, a contact image sensor, a positioning member, and an elastic member. The bar extends along the first edge. The carriage has a bottom surface and a top surface. The bottom surface has a receiving part for receiving the bar. The contact image sensor disposed on a receiving slot of the top surface. The contact image sensor is used for scanning a document. The positioning member is slideably or rotatably disposed on the bottom surface and adjacent to the receiving part. The receiving slot has a hole for the positioning member to be adjacent to the contact image sensor. The elastic member has a first end and a second end. The first end is fixed on the carriage, the second end is fixed on the positioning member, and the elastic member provides an elastic force to the positioning member, enabling the positioning member to slideably or rotatably drive the contact image sensor to move in parallel to plane normal direction, so that the contact image sensor disposed on the carriage presses the scanning platform tightly.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a three-dimensional diagram of a scanning device;

FIG. 2A is a front view showing the bar and the scanning platform keep a standard distance;

FIG. 2B is a front view showing the bar and the scanning platform keep a first distance;

FIG. 2C is a three-dimensional bottom view showing the first embodiment has two positioning members;

FIG. 3 is a three-dimensional diagram showing the second embodiment has two pivotal part;

FIG. 4A is a three-dimensional assembly diagram of the third embodiment;

FIG. 4B is an exploded diagram of the third embodiment; and

FIG. 4C is a cross-sectional diagram along the cross-sectional line 4C-4C′ of FIG. 4B.

### DETAILED DESCRIPTION OF THE INVENTION

### FIRST EMBODIMENT

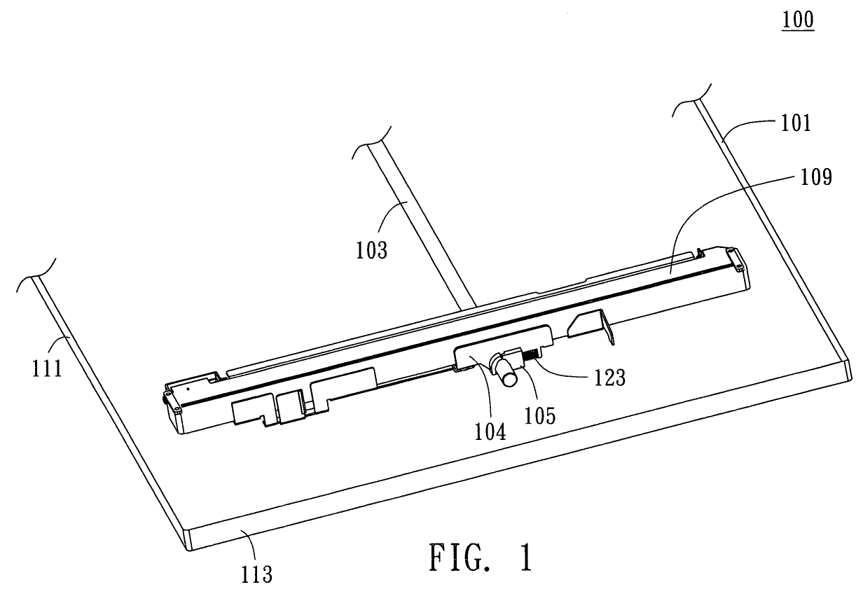

Referring to FIG. 1, a three-dimensional diagram of a scanning device is shown. The scanning device 100 includes a scanning platform 101, a bar 103, a carriage 104, a contact image sensor 109, a positioning member 105 and an elastic member 123. The scanning platform 10 is for placing a document and has a first edge 111 and a second edge 113. The first edge 111 and the second edge 113 define a plane normal direction 115. The bar 103 is parallel to the first edge 111 and is disposed below the scanning platform 101. The contact image sensor 109 can be a contact image sensor for instance in present embodiment. The elastic member 123 can be a spring or an elastic piece for instance in present embodiment.

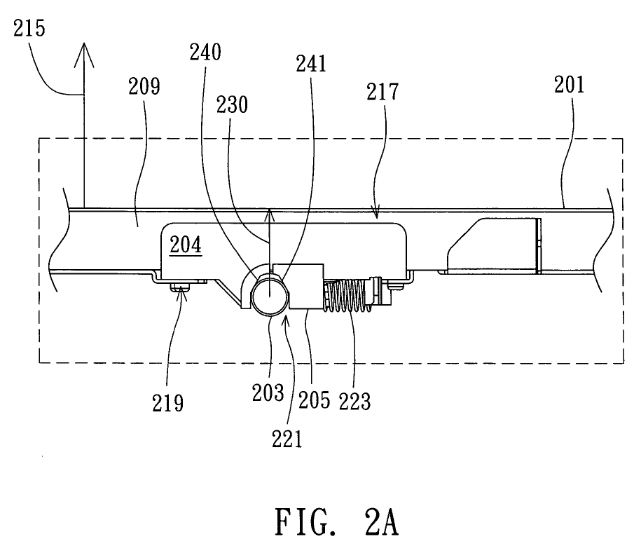

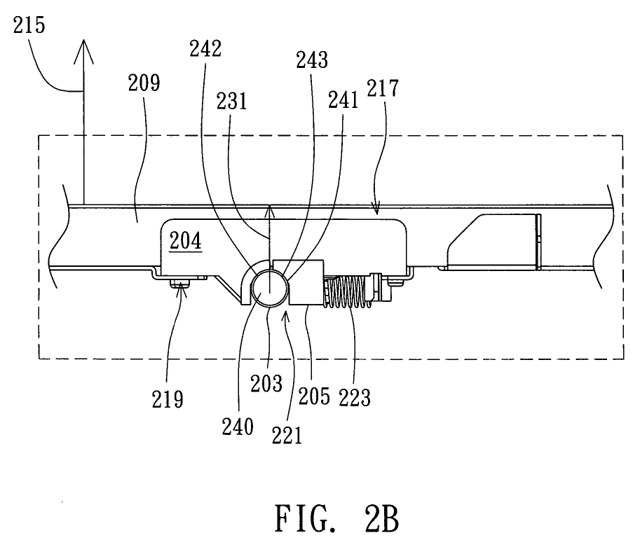

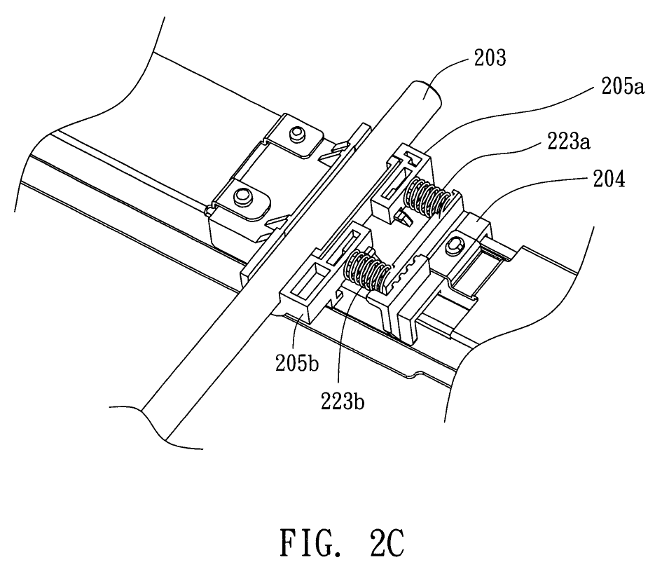

Referring to FIG. 2A, a front view showing the bar and the scanning platform keep a standard distance is shown. The carriage 204 has a bottom surface 219 and a top surface 217. The top surface 217 faces a scanning platform 201. The bottom surface 219 has a receiving part 221. The receiving part 221 is for receiving the bar 203. The carriage 204 is slideably moved below the scanning platform 201 along an extending direction of the bar 203. The contact image sensor 209 is disposed on the top surface 217 and is for scanning the document on the scanning platform 201. The positioning member 205 is slideably disposed on a bottom surface of the carriage 204 and is for pressing against the bar 203. The elastic member 223 is connected to the carriage 204 and the positioning member 205. The elastic member 223 provides an elastic force to the positioning member 205. The elastic force enables the positioning member 205 and the receiving part 221 to apply on the bar 203, so that the contact image sensor 209 presses the scanning platform 201 tightly. The two ends of the elastic member 223 are respectively fixed on the carriage 204. The elastic member 223 provides an elastic force to the positioning member 205, enabling the positioning member 205 to slide and drive the contact image sensor 209 to move in parallel to a plane normal direction 215, so that the contact image sensor 209 disposed on the carriage 204 can tightly press the scanning platform 201. As shown in FIG. 2A, when the scanning platform 201 and the bar 203 keep a standard distance 230, the receiving part 221 contacts the bar 203 by a first contact surface 240 and a second contact surface 241 and has a standard contact surface area.

Referring to FIG. 2B, a front view showing the bar and the scanning platform keep a first distance is shown. When the scanning platform 201 and the bar 203 keep a first distance 231 larger than the standard distance 230, a clearance exists between the scanning platform 201 and the contact image sensor 209. The elastic member 223 pushes the positioning member 205 to move towards the bar 203. The positioning member 223 and the receiving part 221 apply on the bar 203. The carriage 204 moves towards the scanning platform 201 along the plane normal direction 215, enabling the contact image sensor 209 to press the scanning platform 201 tightly. A first contact surface area larger than the standard contact surface area exists between the receiving part 221 and the bar 203. The first contact surface area includes a first contact surface 240, a second contact surface 241, a third contact surface 242 and a fourth contact surface 243.

When the distance between the bar 203 and the scanning platform 201 is smaller than the standard distance 230, implying that compression between the carriage 204 and the scanning platform 201 is too heavy. Meanwhile, the carriage 204 would be pushed downwards by the scanning platform 201. When the positioning member 205 presses against the bar 203, the downward pushing force contracts the elastic member 223 to mitigate the compression between the carriage 204 and the scanning platform 201. Meanwhile, a second contact surface area is created. The second contact surface area is smaller than the standard contact surface area and the first contact surface area. That is, the first contact surface 240 and the second contact surface 241 of FIG. 2A would be smaller than the first contact surface 240 and the second contact surface 241 under normal circumstances.

Referring to FIG. 2C, a three-dimensional bottom view showing the first embodiment has two positioning members is shown. In the first embodiment, with two positioning members 205a and 205b and two elastic members 223a and 223b being respectively disposed below the carriage 204, a constant distance between the carriage 204 and the scanning platform 201 can also be ascertained.

### SECOND EMBODIMENT

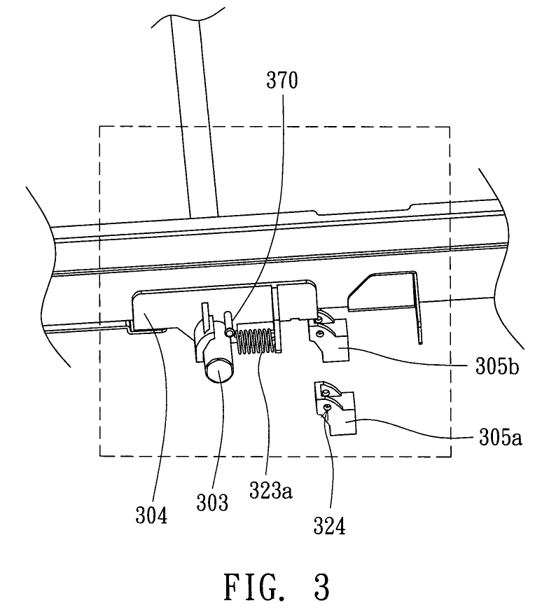

Referring to FIG. 3, a three-dimensional diagram showing the second embodiment has two pivotal parts is shown. The present embodiment differs with the first embodiment in that the positioning member rotates to press against the bar. As shown in FIG. 3, scanning device in present embodiment includes a bar 303, a carriage 304, an elastic member 323a, and two positioning members 305a and 305b. In the present embodiment, the positioning members 305a and 305b are rotatably mounted on the spindle 370. With the spindle 370 being received in axial holes 324 of the positioning member 305a and 305b, the positioning members 305a and 305b are able to rotate around the spindle 370. Like the first embodiment, when the distance between the bar 303 and the scanning platform 301 is smaller than or larger than the standard distance, the elastic member 323a provides an elastic force to the positioning members 305a and 305b, enabling the positioning member 305a and 305b to rotate to press or loosen the bar 303. The positioning member 305a and 305b indirectly drives the carriage 304 to press against the scanning platform 301 so that the standard distance is maintained. The present embodiment can achieve the same object of the invention by using one positioning member and one elastic member or using two positioning members and two elastic members as shown in FIG. 3.

### THIRD EMBODIMENT

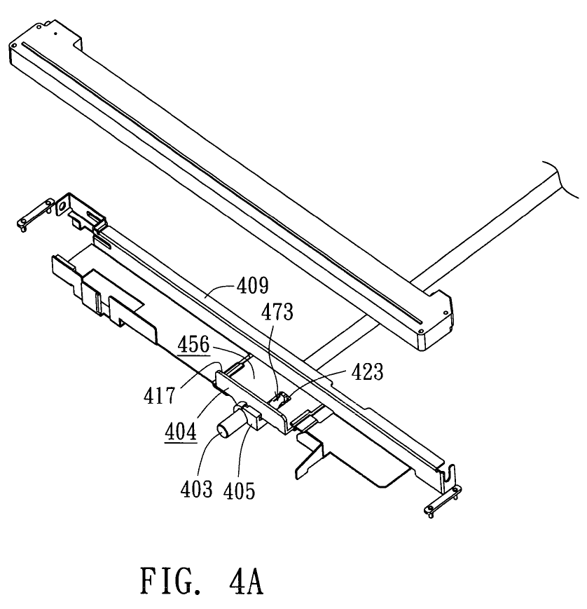

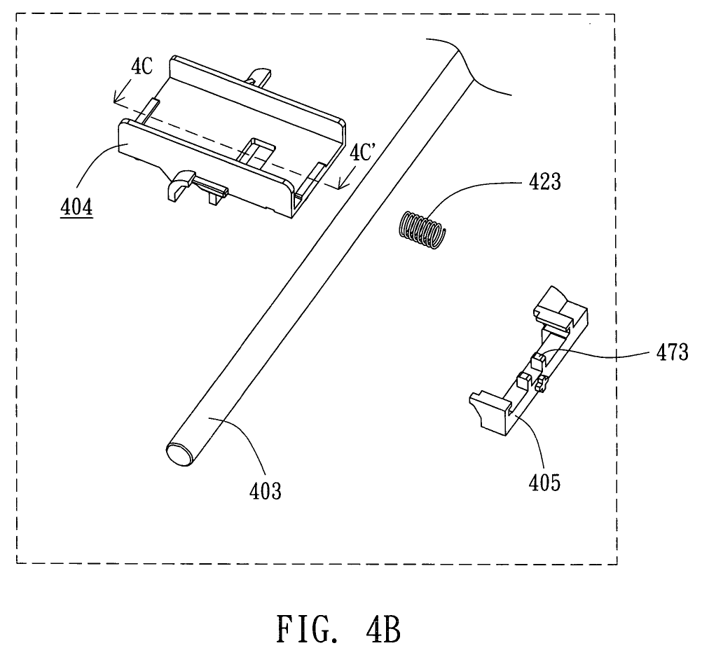

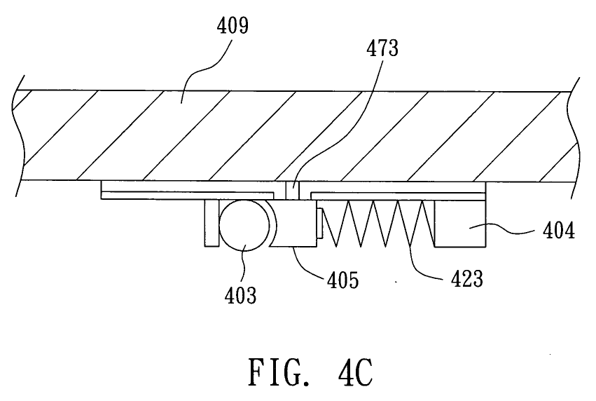

Referring to FIG. 4A, FIG. 4B and FIG. 4C together. FIG. 4A is a three-dimensional assembly diagram of the third embodiment, FIG. 4B is an exploded diagram of the third embodiment, and FIG. 4C is a cross-sectional diagram along the cross-sectional line 4C-4C′ of FIG. 4B. The present embodiment differs with the first embodiment and the second embodiment in that a receiving slot 456. The receiving slot 456 is disposed on the top surface 417 of the contact image sensor 409. The receiving slot 456 has a hole 473, enabling the positioning member 405 to be immediately adjacent to the contact image sensor 409. Like the first and the second embodiments, when the distance between the bar 403 and the scanning platform is smaller than the standard distance during scanning, implying that the compression between the carriage 404 and the scanning platform is too heavy. Meanwhile, the carriage 404 would be pushed downwards by the scanning platform. When the positioning member 405 presses against the bar, the downward pushing force contracts the elastic member 423 to mitigate the compression between the carriage 404 and the scanning platform. The elastic member 423 provides an elastic force to the positioning member 405. The elastic force pushes the positioning member 405 to slideably or rotatably drive the contact image sensor 409 to move in parallel to plane normal direction, enabling the contact image sensor 409 disposed on the carriage 404 to press the scanning platform tightly. Unlike previous embodiments where the carriage is needed when positioning the positioning member, the positioning member can be directly positioned on the contact image sensor in present embodiment. Furthermore, the pivotal part can be disposed on the positioning member, the positioning member can slideably position the carriage, and the position can be achieved by using two positioning members and two elastic members.

According to the scanning device disclosed in above embodiment of the invention, the elastic member and the positioning member are disposed below the contact image sensor. When the distance between the bar and the scanning platform is not constant, the elastic member provides an elastic force driving the positioning member and pressing the carriage and the contact image sensor against the scanning platform tightly. During scanning, the contact image sensor maintains a constant distance with the scanning platform to fix the scanning depth. Consequently, scanning quality is enhanced and product competitiveness is increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning device, comprising:
a scanning platform, which is used for placing a document and has a first edge and a second edge, wherein the first edge and the second edge define a plane normal direction;
a bar, which is parallel to the first edge to be disposed below the scanning platform;
a carriage, which has a bottom surface and a top surface, wherein the top surface faces the scanning platform, the bottom surface has a receiving part for receiving the bar, and the carriage is slideably moved below the scanning platform along an extending direction of the bar;
a contact image sensor, which is disposed on the top surface and is used for scanning the document;
a positioning member, which is slideably or rotatably disposed on the bottom surface and is used for pressing against the bar; and
an elastic member, which is connected to the carriage and the positioning member and is used for providing an elastic force to the positioning member, wherein the elastic force enables the positioning member and the receiving part to apply on the bar, so that the contact image sensor presses the scanning platform tightly.

2. The scanning device according to claim 1, wherein when the scanning platform and the bar keep a standard distance, a standard contact surface area exists between the receiving part and the bar.

3. The scanning device according to claim 2, wherein when the distance between the bar and the scanning platform is smaller than the standard distance, the carriage is pushed downward by the scanning platform and the positioning member presses the bar to contract the elastic member, so that the compression between the carriage and the scanning platform is mitigated.

4. The scanning device according to claim 2, wherein when the scanning platform and the bar have a first distance larger than the standard distance, a clearance exists between the scanning platform and the contact image sensor, the elastic member pushes the positioning member to slide or rotate towards the bar, the positioning member and the receiving part apply on the bar, the carriage moves towards the scanning platform along the plane normal direction to press the contact image sensor against the scanning platform tightly, a first contact surface area larger than the standard contact surface area exists between the receiving part and the bar.

5. The scanning device according to claim 4, wherein the positioning member further comprises a pivotal portion, wherein the positioning member rotates around the pivotal part and drives the carriage and the contact image sensor to move in parallel to the plane normal direction.

6. The scanning device according to claim 1, wherein the contact image sensor is a contact image sensor.

7. The scanning device according to claim 1, wherein the elastic member is a spring or a elastic piece.

8. A scanning device disposed below a scanning platform, wherein the scanning platform, which is for placing a document and has a first edge and a second edge, the first edge and the second edge define a plane normal direction, the scanning device comprises:
a bar, which extends along the first edge;
a carriage, which has a bottom surface and a top surface, wherein the bottom surface has a receiving part for receiving the bar;
a contact image sensor, which is disposed in a receiving slot of the top surface and is used for scanning the document;
a positioning member, which is slideably or rotatably disposed on the bottom surface and is adjacent to the receiving part, wherein the receiving slot has a hole for the positioning member to be immediately adjacent to the contact image sensor; and
an elastic member whose two ends are respectively fixed on the carriage and the positioning member, wherein the elastic member provides an elastic force to the positioning member, enabling the positioning member to slideably or rotatably drive the contact image sensor to move in parallel to the plane normal direction, so that the contact image sensor disposed on the carriage presses the scanning platform tightly.

9. The scanning device according to claim 8, wherein when the scanning platform and the bar keep a standard distance, a standard contact surface area exists between the receiving part and the bar.

10. The scanning device according to claim 8, wherein when the distance between the bar and the scanning platform is smaller than the standard distance, the carriage is pushed downward by the scanning platform and the positioning member presses the bar to contract the elastic member, so that the compression between the carriage and the scanning platform is mitigated.

11. The scanning device according to claim 9, wherein when the scanning platform and the bar have a first distance larger than the standard distance, then a clearance exists between the scanning platform and the contact image sensor, the elastic member pushes the positioning member to slide or rotate towards the bar, the positioning member the receiving part transmit a force to the bar, the carriage moves towards the scanning platform along the plane normal direction to press the contact image sensor against the scanning platform tightly, a first contact surface area larger than the standard contact surface area exists between the receiving part and the bar.

12. The scanning device according to claim 11, wherein the positioning member further comprises a pivotal portion, wherein the positioning member rotates around the pivotal part and drives the carriage and the contact image sensor to move in parallel to the plane normal direction.

13. The scanning device according to claim 8, wherein the contact image sensor is a contact image sensor.

14. The scanning device according to claim 8, wherein the elastic member is a spring or elastic piece.
